(19) United States
(12) Patent Application Publication
(10) Pub. No.: US 2026/0061849 A1
(43) Pub. Date: Mar. 5, 2026

(54) Redundancy Power Control System and Method for Controlling the Same

(71) Applicants: Hyundai Motor Company, Seoul (KR); Kia Corporation, Seoul (KR); EGTRONICS CO., Ltd., Hwaseong-Si (KR)

(72) Inventors: Soon Cheol Hwang, Hwaseong-Si (KR); Eun Jin Jung, Seongnam-Si (KR); Yoon Kyu Shibn, Osan-Si (KR); Ji Hyeong Lee, Hwaseong-Si (KR); Chang Ho Kang, Suwon-Si (KR); Meong Kyu Choi, Yongin-Si (KR)

(21) Appl. No.: 19/229,149

(22) Filed: Jun. 5, 2025

(30) Foreign Application Priority Data
Aug. 28, 2024 (KR) 10-2024-0115967

(51) Int. Cl. B60L 3/00; B60L 58/18; H02M 3/155

(52) U.S. Cl. CPC B60L 3/0023; B60L 3/0092; B60L 58/18; H02M 3/155; B60L 2210/10; B60L 2240/547

(57) ABSTRACT

An apparatus of a vehicle may comprise a first DC-DC converter configured to convert an input voltage into a first voltage, a first power distributor configured to supply the first voltage to at least one first electrical load, a second DC-DC converter configured to convert the input voltage into a second voltage, a second power distributor configured to supply the second voltage to at least one second electrical load, and a bidirectional converter configured to convert power between power associated with the first low-voltage and power associated with the second low-voltage based on a power conversion request signal generated by one power distributor and provide the converted power to the other power distributor. Each power distributor is configured to determine a spare current amount and transmit the power conversion request signal based on a failure in the other DC-DC converter.

### CROSS-REFERENCE TO RELATED APPLICATIONS

The present application claims the benefit of priority to Korean Patent Application No. 10-2024-0115967, filed in the Korean Intellectual Property Office on Aug. 28, 2024, the entire contents of which are incorporated herein for all purposes by reference.

### TECHNICAL FIELD

The present disclosure relates to a low-voltage supply method in an autonomous electric vehicle.

### BACKGROUND

The matters described in this Background section are only for enhancement of understanding of the background of the disclosure, and should not be taken as acknowledgment that they correspond to prior art already known to those skilled in the art.

In an automotive-related industry, there has been an ongoing demand to improve a fuel economy in view of environmental considerations and rising fuel cost. Accordingly, various researches and developments are being performed to enhance vehicle efficiency. For example, regulatory measures such as corporate average fuel economy (CAFE) standards have led to increased exploration of energy-efficient vehicle technologies. As a part of this technological development, vehicle developments such as a battery EV and a Hybrid EV that use electrical energy are being actively examined.

In particular, efforts to build infrastructure for commercialization of intelligent vehicles and expansion of an autonomous vehicle market have led to a continuous investment in autonomous vehicles, including a domestic market. Autonomous vehicles, which are capable of autonomously monitoring external information, recognizing a road condition, and driving to a set destination without a driver intervention, may require additional power to operate various sensors and computing systems compared to other vehicles.

For example, since the autonomous vehicle may be operated with a sensor, an internal MCU, and a steering system without intervention of the driver, a problem occurring in internal power may lead a major accident due to lack of power of various sensors, steering systems, or brakes.

A short circuit or disconnection in a power system of an autonomous vehicle may occur due to an internal defect or an external factor while the vehicle is in motion, potentially resulting in unintended vehicle stops.

In order to solve the above-described problem, an autonomous vehicle system may realize a redundancy technology that has dual ECUs and dual power supply devices for emergency driving to a destination without the intervention of the driver although a malfunction occurs.

The redundancy technology is developed in various forms depending on unique characteristics of each vehicle manufacturer. A manufacturer that uses a component using a first operating voltage 12V and a component using a second operating voltage 24V may implement redundancy technology including a low DC-DC converter (LDC) for converting a voltage of a high-voltage main battery into the first operating voltage 12V and the second operating voltage 24V, along with auxiliary batteries for the first operating voltage 12V and the second operating voltage 24V as reserves.

Here, when the 24V LDC fails, the 12V battery may be required to supply a maximum discharge power. In this case, autonomous driving may become impossible because the 12V battery is completely discharged after about 36 minutes, based on simulation result.

### SUMMARY

The present disclosure is intended to solve the above-described problems.

The present disclosure relates to a low-voltage supply method in an autonomous electric vehicle. A redundancy power control system may perform a variable power conversion based on an output capacity of a low DC-DC converter (LDC) of a normal source domain to resolve a limitation generated when conversion supply routes of a failed low-voltage and another low-voltage perform power conversion with a fixed current amount (maximum current) in a state in which a limitation occurs in conversion supply of different kinds of low-voltages, e.g., a first low-voltage 12V or a second low-voltage 24V, in a vehicle to which a redundancy power conversion technology is applied.

According to the present disclosure, an apparatus of a vehicle, the apparatus may comprise, a first DC-DC converter configured to convert an input voltage into a first voltage, a first power distributor configured to supply the first voltage output from the first DC-DC converter to at least one first electrical load, a second DC-DC converter configured to convert the input voltage into a second voltage, a second power distributor configured to supply the second voltage output from the second DC-DC converter to at least one second electrical load, and a bidirectional converter configured to, convert power between power associated with the first low-voltage and power associated with the second low-voltage based on a power conversion request signal generated by one power distributor and, provide the converted power to the other power distributor, wherein, the first DC-DC converter is further configured to provide an indication of a first maximum convertible power output to the first power distributor, and the second DC-DC converter is further configured to provide an indication of a second maximum convertible power output to the second power distributor, wherein, the first power distributor is further configured to determine a first spare current amount based on the first maximum convertible power output and a first current amount consumed by the at least one first electrical load and provide the first spare current amount to the bidirectional converter, and the second power distributor is further configured to determine a second spare current amount based on the second maximum convertible power output and a second current amount consumed by the at least one second electrical load and provide the second spare current amount to the bidirectional converter, and wherein, the first power distributor is further configured to transmit, based on a failure in the first DC-DC converter, the power conversion request signal to the bidirectional converter for a first target current amount of power conversion, wherein the first target current amount is determined based on the second spare current amount, and the second power distributor is further configured to transmit, based on a failure in the second DC-DC converter, the power conversion request signal to the bidirectional converter for a second target current amount of power conversion, wherein the second target current amount is determined based on the first spare current amount.

The apparatus, wherein the first DC-DC converter outputs a voltage in a range from 11V to 13V.

The apparatus, wherein the second DC-DC converter outputs a voltage in a range from 23V to 25V.

The apparatus, wherein at least one of, the first DC-DC converter is further configured to provide, based on a first set time period, the indication of the first maximum convertible power output to the first power distributor, or the second DC-DC converter is further configured to provide, based on a second set time period, the indication of the second maximum convertible power output to the second power distributor.

The apparatus, wherein, the first target current amount of power conversion is determined based on the second current amount and a second maximum convertible output current amount of the second DC-DC converter within the second spare current amount, or the second target current amount of power conversion is determined based on the first current amount and a first maximum convertible output current amount of the first DC-DC converter within the first spare current amount.

The apparatus, wherein, the first current amount is determined based on a first moving average of first current data consumed by the at least one first electrical load over a first predetermined time, or the second current amount is determined based on a second moving average of second current data consumed by the at least one second electrical load over a second predetermined time.

The apparatus, wherein, the first DC-DC converter is configured to transmit at first predetermined time intervals, based on the vehicle being started, the first current data to the first power distributor, or the second DC-DC converter is configured to transmit at second predetermined time intervals, based on the vehicle being started, the second current data to the second power distributor, and wherein, the first power distributor is further configured to determine, based on a failure in the first DC-DC converter, the first moving average of the first current data, or the second power distributor is further configured to determine, based a failure in the second DC-DC converter, the second moving average of the second current data.

According to the present disclosure, a method performed by an apparatus of a vehicle, the method may comprise, determining whether a failure of a second DC-DC converter occurs, wherein a first DC-DC converter converts an input voltage to a first voltage, and wherein the second DC-DC converter converts the input voltage to a second voltage, providing, based on a determination that the failure of the second DC-DC converter occurs and using the first DC-DC converter, an indication of a first maximum convertible power output to a first power distributor, wherein the first power distributor supplies the first voltage output from the first DC-DC converter to at least one first electrical load, checking, using the first power distributor, a first current amount consumed by the at least one first electrical load, transmitting, based on the first maximum convertible power output and the first current amount and using the first power distributor, an indication of a first spare current amount to a second power distributor, wherein the second power distributor supplies the second voltage output from the second DC-DC converter to at least one second electrical load, transmitting, based on a target current amount and using the second power distributor, a power conversion request to a bidirectional converter, wherein the target current amount is determined based on the first spare current amount, converting, based on the power conversion request and using the bidirectional converter, power associated with the first low-voltage into power associated with the second low-voltage and supplying the converted power associated with the second voltage to the second power distributor within a range of the target current amount, and supplying, to the at least one second electrical load, a combination of power received by the second power distributor from the bidirectional converter and power discharged from a second voltage battery associated with the second power distributor.

The method, wherein the determining whether the failure of the second DC-DC converter occurs may comprise determining that the second DC-DC converter failed based on an output voltage of the second DC-DC converter is less than or equal to a preset threshold.

The method, wherein the second voltage is higher than the first voltage.

The method, wherein the supplying the combination of power to the at least one second electrical load is performed until remaining power of the second voltage battery is less than or equal to a preset first threshold value.

The method, wherein the preset first threshold value corresponds to a state of charge of the second voltage battery in a range from 59% to 61%.

The method may further comprise, stopping the vehicle based on the remaining power of the second voltage battery being less than or equal to a preset second threshold value, and restricting power usage of the at least one first electrical load and the at least one second electrical load.

The method may further comprise charging the second voltage battery to a preset third threshold value using power converted into the power associated with the second voltage by the bidirectional converter.

The method, wherein the preset third threshold value corresponds to a state of charge of the second voltage battery in a range from 99% to 100%.

The method may further comprise, checking a driving path of the vehicle to a preset destination based on the second voltage battery being charged to the preset third threshold value, driving the vehicle along the checked driving path, and re-evaluating whether a failure of the second DC-DC converter occurs during the driving.

According to the present disclosure, an apparatus may comprise, a processor, and a memory storing at least one instruction that, when executed by the processor communicating with the memory, is configured to cause the apparatus to, receive, from a plurality of power converters, respective power output information, determine, for the plurality of power converters, a respective current consumption amount associated with at least one electrical load connected to a corresponding power converter, determine, based on the respective power output information and the respective current consumption amount, a respective spare capacity for the plurality of power converters, detect at least one power converter with a fault condition among the plurality of power converters, determine, based on the fault condition and a spare capacity of at least one non-faulty power converter among the plurality of power converters, a target power conversion value, and control, based on the target power conversion value, a bidirectional converter to convert power from the non-faulty power converter to compensate for the fault condition.

The apparatus, wherein at least one of the plurality of power converters is configured to provide respective power output information to the processor at a set time interval.

The apparatus, wherein the at least one instruction, when executed by the processor communicating with the memory, is configured to cause the apparatus to determine, based on a moving average of the respective current consumption amount over a predetermined number of previous time intervals, the respective spare capacity.

The apparatus, wherein the at least one instruction, when executed by the processor communicating with the memory, is configured to cause the apparatus to control the bidirectional converter to, convert power in a first direction in response to a first fault condition occurring in a first power converter, and convert power in a second direction in response to a second fault condition occurring in a second power converter.

### BRIEF DESCRIPTION OF THE DRAWINGS

FIG. 1 shows an example of a redundancy architecture of a vehicle to which a redundancy power conversion method according to the present disclosure is applied.

FIG. 2 shows an example of a redundancy power supply process and a path thereof when a 24V low DC-DC converter (LDC) fails in FIG. 1.

FIG. 3 shows an example of a redundancy power supply process and a path thereof at a charging operation timing due to discharging of a 24V battery module in FIG. 2.

FIG. 4 shows an example of a redundancy power supply process and a path thereof when the 12V LDC fails in FIG. 1, which are accompanying drawings.

### DETAILED DESCRIPTION

Since the present disclosure may have diverse modified examples, preferred examples are illustrated in the drawings and are described in the detailed description of the disclosure. However, this does not limit the present disclosure within the specific examples and it should be understood that the present disclosure covers all the modifications, equivalents, and replacements within the idea and technical scope of the present disclosure.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

It will be understood that although the terms of “first” and “second” are used herein to describe various elements, these elements should not be limited by these terms. These terms may be used solely to differentiate one component from another in name, and their sequential meanings are understood through the context of the description rather than by the names themselves.

The term “and/or” is used to include all possible combinations of the listed items. For example, “A and/or B” includes all three cases of “A”, “B”, and “A and B”. For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

It will also be understood that when an element is referred to as being “‘connected to” or “engaged with” another element, it can be directly connected to the other element, or intervening elements may also be present.

In the following description, the technical terms are used only for explaining a specific example while not limiting the present disclosure. The terms of a singular form may include plural forms unless referred to the contrary. The meaning of ‘include’ or ‘comprise’ specifies a property, a region, a fixed number, a step, a process, an element and/or a component but does not exclude other properties, regions, fixed numbers, steps, processes, elements and/or components.

Unless terms used in the present disclosure are defined differently, the terms may be construed as meaning known to those skilled in the art. Terms such as terms that are generally used and have been in dictionaries should be construed as having meanings matched with contextual meanings in the art. In this description, unless defined clearly, terms are not ideally, excessively construed as formal meanings.

Also, the terms unit, control unit, control device, or controller are widely used to name devices that control specific functions and do not refer to a generic functional unit. Also, the devices denoted by the names may include a communication device that communicates with another controller or sensor to control the corresponding function, a computer-readable recording medium that stores an operation system, a logic command, and input/output information, and at least one processor that performs determinations, decisions, and calculations required for function control.

On the other hand, the processor may include semiconductor integrated circuits and/or electronic elements that perform at least one or more of comparisons, determinations, calculations, and decisions to achieve programmed functions. For example, the processor may be a computer, a microprocessor, CPU, ASIC, an electronic circuitry (logic circuits), or a combination thereof.

Also, the computer readable recording medium (or memory) includes all sorts of data storage devices that store computer readable data. For example, the computer readable recording medium may include at least one of a flash memory type, hard disk type, micro type, card type (e.g., secure digital (SD) card) or eXtream digital (XD) type memory and a random access memory (RAM), static RAM (SRAM), read-only memory (ROM), programmable ROM (PROM), electrically erasable PROM (EEPROM), magnetic RAM (MRAM), magnetic disk, or optical disk type memory.

These recording media may be electrically connected to the processor, and the processor may read data from and write data to the recording media. The recording media and the processor may be integrated with each other or physically separated from each other.

Hereinafter, a method for converting redundancy power (hereinafter, referred to as a redundancy power conversion method) and a system for the same according to an example of the present disclosure will be described with reference to the accompanying drawings.

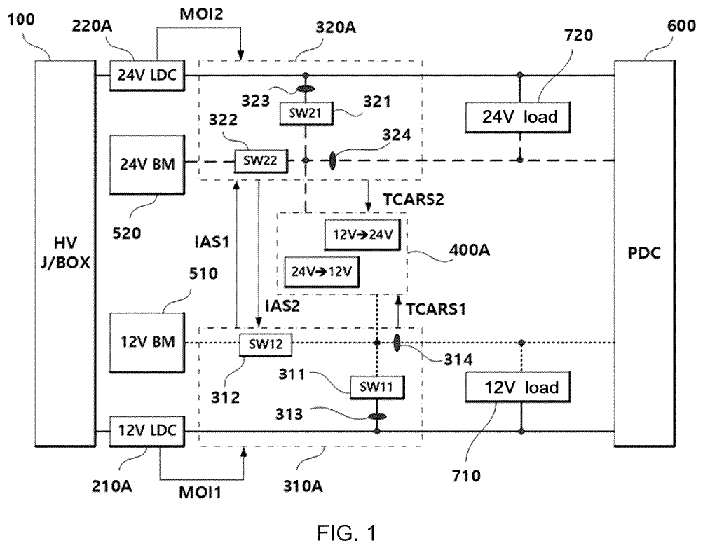

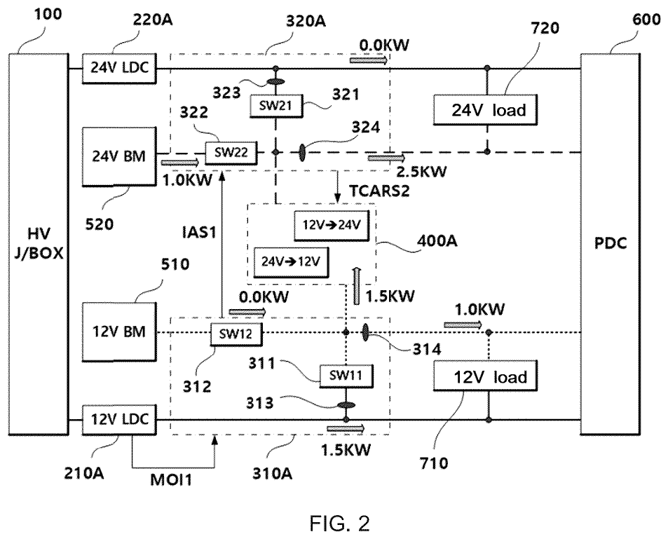

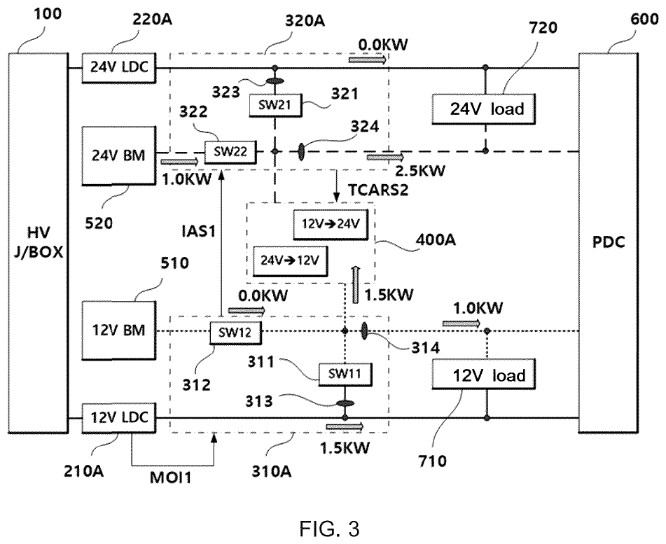

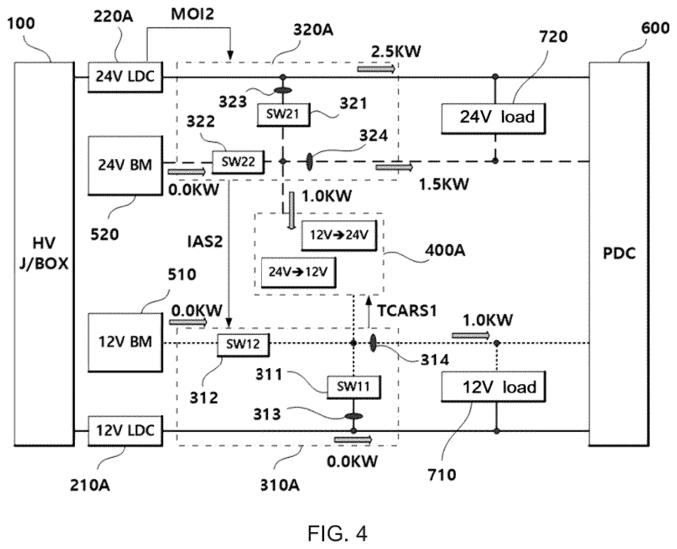

FIG. 1 shows an example of a redundancy architecture of a vehicle to which a redundancy power conversion method according to the present disclosure is applied, such as an electric or autonomous vehicle. FIG. 2 shows an example of a redundancy power supply process and a path (e.g., a power flow path) when a 24V low DC-DC converter (LDC) fails (e.g., due to hardware malfunction, overheating, or overcurrent protection) in FIG. 1. FIG. 3 shows an example of a redundancy power supply process and a path thereof at a charging operation timing due to discharging of a 24V battery module (e.g., lead-acid, lithium-ion, or other low-voltage storage devices) in FIG. 2. FIG. 4 shows an example of a redundancy power supply process and a path thereof when the 12V LDC fails in FIG. 1, such as during operation of safety-critical loads including sensors, ECUs, or steering actuators, which are accompanying drawings.

As illustrated in FIG. 1, the redundancy architecture of an autonomous vehicle to which the redundancy power control method according to the present disclosure is applied includes, for example:
a high voltage junction box (hereinafter, referred to as HV J/BOX) 100 for distributing a high voltage supplied from a main battery (not shown), such as a lithium-ion traction battery or other high-capacity energy source;
a first active junction box (AJB) 310A including a back-to-back (B2B) switch, which receives a first low-voltage 12V that is output by converting a high voltage supplied from the HV J/BOX 100 in a 12V low DC-DC converter (LDC) 210A and supplies the received first low-voltage 12V to a first electrical load (vehicle 12V load) 710 connected to a rear end thereof, such as control circuits, infotainment systems, or safety sensors, etc.;
a second AJB 320A including a B2B switch, which receives a second low-voltage 24V that is output by converting a high voltage supplied from the HV J/BOX 100 in a 24V LDC 220A and supplies the received second low-voltage 24V to a second electrical load (vehicle 24V load) 710 connected to the rear end, such as electric power steering, brake control circuitry, or autonomous driving processors, etc.;
a redundancy power converter (RPC) 400A that converts a low-voltage output from the 12V LDC 210A or the 24V LDC 220A into a low-voltage having a different magnitude according to a power conversion request signal TCARS1 and TCARS2 generated by the first AJB 310A or the second AJB 320A and provides the converted low-voltage to the first AJB 310A or the second AJB 320A that generates the power conversion request signal, thereby supporting bidirectional backup power transfer in case of failure or overload in either voltage domain; and
a power-net domain controller (PDC) 600 that supplies the introduced first low-voltage 12V or second low-voltage 24V to the electrical load (not shown) connected to the rear end, such as distributed loads for lighting, sensors, or autonomous driving actuators, etc.

Here, the first electrical load (vehicle 12V load) 710 and the second electrical load (vehicle 24V load) refer to a plurality of electrical loads required for driving the vehicle, such as control circuits, lighting systems, infotainment circuitry, steering actuators, or autonomous navigation systems, etc., which are simplified for descriptions thereof.

Also, power converters, such as the 12V LDC 210A and/or the 24V LDC 220A provide power output information, for example, information on maximum convertible output information MOI1 and MOI2 at predetermined equal time intervals (e.g., 1 second in the example of the present disclosure) to power distributors, for example, the first AJB 310A and/or the second AJB 320A, thereby enabling real-time power availability monitoring and redundancy control.

Accordingly, the first AJB 310A and/or the second AJB 320A calculates a current consumption amount of the first electrical load 710 and/or the second electrical load 720 connected to the rear end, such as by measuring average load currents, peak demand values, or time-varying power profiles, etc., calculates an amount of spare based on the maximum output information received from the 12V LDC 210A and/or the 24V LDC 220A, and then provides information based on the calculated amount of spare to the other AJB, enabling cross-domain balancing, fault compensation, or dynamic load redistribution.

For example, the first AJB 310A provides information on an amount of spare IAS1 to the second AJB 320A, and the second AJB 320A provides information on the amount of spare IAS2 to the first AJB 310A, thereby allowing coordinated bidirectional power flow management, such as adaptive voltage bridging, redundant power sharing between isolated subsystems, dynamic failover control, or load balancing across voltage domains, etc.

Accordingly, the first AJB 310A and/or the second AJB 320A determines whether a failure occurs in the 12V LDC 210A and/or the 24V LDC 220A (e.g., determines as a failure when an output voltage is zero or below a defined fault threshold), so that the AJB connected to the failed LDC (e.g., LDC under a limited condition or a fault condition) requests the RPC 400A to perform power conversion based on a target current amount request signal TCARS1 and TCARS2 selected based on the amount of spare provided from the other AJB.

Here, the target current amount is calculated by subtracting a used current amount from a maximum output current amount of the LDC connected to the AJB, based on a range of the amount of spare provided from the other AJB, such as remaining conversion capacity, available voltage margin, or reserve load tolerance, etc.

For example, the used current amount is determined by evaluating a trend variation amount of information on an output spare amount of the LDC using a moving average (e.g., a simple moving average (SMA) where all values in a time window are equally weighted or weighted or exponential moving average (WMA/EMA) where recent values are given more importance, etc.), and the target current amount is determined based on the trend variation amount. The used current amount of the 12V (or in a range from 11V to 13V) LDC 210A and/or the 24V (or in a range from 23V to 25V) LDC 220A is transmitted every second to the first AJB 310A and/or second AJB 320A connected to the rear end, and if a failure occurs in one of the 12V LDC 210A or the 24V LDC 220A during driving, the AJB connected to the failed LDC calculates a moving average and then determines the target current amount to be requested to the RPC, thereby enabling real-time power redistribution while avoiding battery over-discharge or converter overload.

### Since a Description on This Will Be Provided Later With Reference to FIGS. 5 to 7, a detailed description is omitted.

Also, the moving average is determined by using two methods. A first method is a simple moving average of n-th data. The first method uses a total average of n-th history data and n-1-th history data, which smooths out transient spikes or drops in fluctuating load environments.

Another method corresponds to an n-th moving average using the FIFO method, which is performed with an equation: (previous moving average)+(newest in-value-oldest out-value)/n, allowing fast adaptation to changing load profiles without memory overload.

Here, n is generally set to 300 (5 minutes). If a total driving time is less than 5 minutes, an average value of the last driving history is applied, which may reflect recent load behavior during short trips or power-up scenarios.

In the redundancy architecture of the autonomous vehicle to which the redundancy power conversion method according to the present disclosure is applied in FIG. 1, the first AJB 310A and/or the second AJB 320A diagnoses whether a failure occurs in one of the 12V LDC 210A and/or the 24V LDC 220A through a first potential sensor 313 and/or a third potential sensor 323, which may include analog voltage monitors, digital comparators, or fault-detection microcontrollers, etc.

That is, when the 24V LDC 220A fails, a signal detected by the third potential sensor 323 may be zero potential, and when the 12V LDC 210A fails, a signal detected by the first potential sensor 313 may be also zero potential, indicating a critical failure state such as open circuit, fuse breakage, or internal converter fault, an inactive or disabled converter path that triggers redundant compensation through the RPC, etc.

Thus, attached FIGS. 2 and 3 show examples of a redundancy power supply process when the 24V LDC 220A fails. FIG. 4 shows an example of a redundancy power supply process when the 12V LDC 210A fails.

First, a case in which the redundancy power supply process is activated when the 24V LDC 220A fails will be described with reference to FIGS. 2 and 3. In FIG. 2, when a signal detected by the third potential sensor 323 has a potential equal to a preset threshold potential (zero potential) during driving, i.e., if the 24V LDC 220A is determined to be failed, the 12V LDC 210A provides maximum current amount information MOI1 to the first AJB 310A, enabling power sharing from the 12V domain.

Here, the first AJB 310A checks a used current amount of the first electrical load 710 connected to the rear end, such as infotainment systems, control circuitry, or lighting circuits, etc.

The first AJB 310A transmits spare current amount information IAS1, which is calculated based on the maximum current amount MOI1 and the used current amount, to the second AJB 320A, indicating how much available 12V capacity can be safely redirected.

The second AJB 320A requests, to the RPC 400A, a power conversion request signal TCARS2 according to the target current amount based on the spare current amount information, thereby initiating bidirectional voltage conversion from the 12V domain to the 24V domain.

Here, the power conversion target current amount TCARS2 of the second AJB 320A, which is selected based on the spare current amount information IAS1, is 1.5 KW. Thus, when the RPC 400A converts 12V provided by the first AJB 310A to a voltage of 24V, total power does not exceed 1.5 KW, ensuring current control within safe conversion margins and preventing overloading.

Here, since the second electrical load 720 may consume power of 2.5KW, such as steering actuators, brake controllers, or autonomous driving processors, etc., necessary power of 1 KW in addition to the 1.5 KW provided by the first AJB 310A and the RPC 400A is discharged from the 24V battery module 520.

Thus, the second electrical load 720 may receive normal driving power, with no service interruption, and the 24V battery module 520 may supply only 1KW power instead of all the 2.5KW power to maintain a predetermined level of discharge efficiency, thereby extending usable driving duration and preserving critical battery reserves.

The above-described process is performed until the remained power of the 24V battery module 520 is below the preset threshold value (60% of SOC), and if it reaches the threshold value, the vehicle is stopped. Here, a stop position is obtained by selecting an arbitrary place determined to be safe at a current position on the driving path to the destination.

When the autonomous vehicle is stopped, the redundant power supply process is performed as in FIG. 3. First, since the vehicle is stopped, power usage of the first electrical load 710 and the second electrical load 720 is minimally restricted, such as disabling non-critical loads like entertainment systems or cabin lighting, and then, 2.5KW power of 24V is supplied from the first AJB 310A to the second AJB 320A according to the maximum current amount of the 12V LDC 210A, enabling battery recovery and stabilized recharge operation during idle conditions.

Here, all of the information on the amount of spare IAS1 and the power conversion target current amount TCARS2 of the second AJB 320A, which is selected based on the information on the amount of spare IAS1 are 2.5 kW. The 12V LDC 210A converts the voltage of the high-voltage main battery to output 2.5 kW power of 12V. When converting the 12V provided by the first AJB 310A to a voltage of 24V according to the power conversion target current amount TCARS2 of the second AJB 320A, a total power amount does not exceed 2.5 kW, ensuring that the charge current remains within the converter's safe operating envelope.

The converted power charges the 24V battery module 520 up to a predetermined threshold value (100% or in a range from 98 % to 100% of SOC). When the 24V battery module 520 is completely charged, the driving path to the preset destination is checked, for example, based on the current vehicle position, route priority, and power availability, and then the vehicle is driven along the checked driving path. Here, the redundancy power supply process as in FIG. 5 is performed again, enabling continued operation with automatic reentry into fault-handling mode if needed.

Thus, while autonomous driving is practically impossible because the 12V battery module 510 is completely discharged after about 36 minutes in a simulated test, the 24V battery module 520 is dropped to a level of 60% of SOC after about 2 hours and 30 minutes, and the autonomous driving is possible during that time in terms of simulation in a situation of FIG. 2 according to the present disclosure, showing a significant improvement in endurance and safe-operating range under failure conditions.

Thereafter, the 24V battery module 520 is charged according to the process in FIG. 3, and the process in FIG. 2 is performed again, forming a repeatable loop of recovery and operational redundancy. Accordingly, the autonomous driving to the destination is possible even if a failure occurs in the 24V LDC 220A, ensuring vehicle continuity and safety in real-world failure scenarios.

On the other hand, as shown in FIG. 4, if a signal detected by the first potential sensor 313 during driving has a potential equal to the preset threshold potential (zero potential), i.e., if the 12V LDC 210A is determined as a failure, the 24V LDC 220A provides the maximum output information MOI2 to the second AJB 320A, and the second AJB 320A checks a used current amount of the second electrical load 720 connected to the rear end, which may include high-power loads such as electric drive components, sensors, or computing units, etc.

The second AJB 320A transmits the information of the amount of spare IAS2 calculated based on the maximum output information MOI2 and the used current amount to the first AJB 310A, thereby enabling 12V power support using spare 24V capacity.

The first AJB 310A requests the power conversion request signal TCARS1 to the RPC 400A according to the target current amount based on the amount of spare, thereby initiating 24V-to-12V conversion to maintain power continuity in the 12V domain.

Here, the power conversion target current amount TCARS1 of the first AJB 310A, which is determined based on the amount of spare IAS2, is 1.0 kW. Thus, the RPC 400A converts the 24V provided by the second AJB 320A into a voltage of 12V according to power conversion target current amount TCARS1 of the first AJB 310A, ensuring that the converted power does not exceed 1.0 kW and remains within design safety thresholds.

Here, since the first electrical load 710 may consume 1.0 kW power, such as infotainment controllers, ADAS sensors, or gateway ECUs, etc., additional power is not required in addition to the 1.0 kW power supplied by the second AJB 320A and the RPC 400A, allowing stable operation without drawing from the 12V backup battery.

Thus, discharge is not generated from the 12V battery module 510, allowing the battery to remain fully charged and available for future emergency or cold-start scenarios.

Thus, the autonomous driving to the destination is continued without a separate power loss, ensuring uninterrupted operation of mission-critical systems such as perception sensors, steering controllers, or vehicle communication modules, etc.

The above-described B2B in this example may include an integrated circuit (IC) and a plurality of field effect transistors (FETs) and turns on/off a bidirectional current flow through the FET as the IC controls a gate voltage of the FET. Here, if the current is equal to or greater than a reference value, the current flow may be blocked in terms of hardware, i.e., through the gate voltage control of the IC, thereby blocking a current flow when a large amount of overcurrent occurs, such as short circuits, sudden surges, or system fault transients.

Also, the AJB may include a microcontroller unit, a current/voltage sensor, a B2B, and a relay capable of turning the current flow on/off, thereby performing both real-time power switching and protection coordination across power domains.

The PDC may include a memory for storing a program for performing the corresponding function and a processor capable of executing the program, such as managing load priorities, distributing available current, or monitoring SOC thresholds across batteries and converters, etc.

Also, the RPC may include a microcontroller unit, a voltage conversion circuit for step-up or step-down, and a B2B disposed between the voltage conversion circuit and a high-voltage, enabling precise bidirectional voltage control and fault-tolerant power delivery between 12V and 24V systems, or other low-voltage rails.

The present disclosure provides a redundancy power control system for performing a variable power conversion based on an output capacity of a low DC-DC converter (LDC) of a normal source domain to resolve a limitation generated when conversion supply routes of a failed low-voltage and another low-voltage perform power conversion with a fixed current amount (maximum current) when a different kinds of low-voltages, i.e., a first low-voltage 12V or a second low-voltage 24V in a vehicle to which a redundancy power conversion technology is applied.

An example of the present disclosure provides a redundancy power control system including a first low DC-DC converter (LDC) configured to convert a high-voltage into a first low-voltage, a first power distributor configured to supply the first low-voltage output from the first LDC to at least one first electrical load, a second LDC configured to convert the high-voltage into at least one second low-voltage, a second power distributor configured to supply the second low-voltage output from the second LDC to a second electrical load, and a bidirectional converter configured to convert power between the first low-voltage and the second low-voltage according to a power conversion request signal generated by one power distributor of the first power distributor and the second power distributor and provide the converted power to the other power distributor of the first power distributor and the second power distributor, wherein the first LDC is further configured to provide first maximum convertible output information to the first power distributor, and/or the second LDC is further configured to provide second maximum convertible output information to the second power distributor, wherein the first power distributor, is further configured to determine a first spare current amount based on the first maximum convertible output information and a first current amount consumed by the at least one first electrical load to provide the first spare current amount to the bidirectional converter, and/or the second power distributor is further configured to determine a second spare current amount based on the second maximum convertible output information and a second current amount consumed by the at least one second electrical load to provide the second spare current amount to the bidirectional converter, and wherein the first power distributor, in response to a failure occurrence in the first LDC is further configured to transmit the power conversion request signal to the bidirectional converter for a first target current amount of the power conversion determined based on the second spare current amount, or the second power distributor, in response to a failure occurrence in the second LDC is further configured to transmit the power conversion request signal to the bidirectional converter for a second target current amount of the power conversion determined based on the first spare current amount.

In an example, the first LDC may output a 12V low-voltage.

In an example, the second LDC may output a 24V low-voltage.

In an example, the first LDC is further configured to provide the first maximum convertible output information to the first power distributor based on a first set time period and/or the second power distributor is further configured to provide the second maximum convertible output information to the second power distributor based on a second set time period.

In an example, the first target current amount of power conversion is determined based on the second current amount and a second maximum convertible output current amount of the second LDC within the second spare current amount, or the second target current amount of power conversion is determined based on the first current amount and a first maximum convertible output current amount of the first LDC within the first spare current amount.

In an example, the first current amount is determined based on a first moving average of first current data consumed by the at least one first electrical load over a first predetermined time, or the second current amount is determined based on a second moving average of second current data consumed by the at least one second electrical load over a second predetermined time.

In an example, the first LDC is configured to transmit the first current data in response to the vehicle being started at first predetermined time intervals to the first power distributor, or the second LDC is configured to transmit the second current data in response to the vehicle being started at second predetermined time intervals to the second power distributor, and wherein the first power distributor is further configured to determine the first moving average of the first current data when a failure occurs in the first LDC, or the second power distributor is further configured to determine the second moving average of the second current data when a failure occurs in the second LDC.

In an example of the present disclosure, there is provided a method for controlling a redundancy power control system including a first low DC-DC converter (LDC) configured to convert a high-voltage into a first low-voltage, a first power distributor configured to supply the first low-voltage output from the first LDC to at least one first electrical load, a second LDC configured to convert the high-voltage into a second low-voltage, a second power distributor configured to supply the second low-voltage output from the second LDC to at least one second electrical load, and a bidirectional converter configured to convert power between the first low-voltage and the second low-voltage according to a power conversion request signal generated by one power distributor of the first power distributor and the second power distributor and provide the converted power to the other power distributor of, the first power distributor and the second power distributor, wherein the method includes determining that a failure of the second LDC occurs, providing, by the first LDC, first maximum convertible output information to the first power distributor when in response to a determination that the failure of the second LDC occurs, checking, by the first power distributor, a first current amount consumed by the at least one first electrical load, transmitting, by the first power distributor, first spare current amount information to the second power distributor based on the first maximum convertible output information and the first current amount, transmitting, by the second power distributor, a power conversion request according to a target current amount determined based on the first spare current amount information to the bidirectional converter, converting, by the bidirectional converter, the first low-voltage supplied by the first power distributor into the second low-voltage to supply the converted second low-voltage to the second power distributor within a range of the target current amount, and supplying combined power of power supplied by the first power distributor and discharge power of the second low-voltage battery to the at least one second electrical load.

In an example, the determining that a failure of the second LDC occurs comprises determining that the second LDC fails if an output voltage of the second LDC is less than or equal to a preset threshold.

In an example, the second low-voltage is higher than the first low-voltage.

In an example, the supplying the combined power to the at least one second electrical load is performed until remained power of the second low-voltage battery is less than or equal to a preset first threshold value.

In an example, the preset first threshold value is 60% of SOC.

In an example, the method may further include stopping the vehicle if the remained power of the second low-voltage battery is less than or equal to a preset second threshold value in the supplying the combined power to the at least one second electrical load, restricting power usage of the at least one first electrical load and the at least one second electrical load, and converting, by the bidirectional converter, the first low-voltage into the second low-voltage to supply the converted second low-voltage o the second power distributor.

In an example, the method may further include charging the second low-voltage battery to a preset third threshold value by using the converted second low-voltage.

In an example, the preset third threshold value may be 100% of SOC.

In an example, the method may further include checking a driving path to a preset destination when the second low-voltage battery is charged up to the preset third threshold value, driving a vehicle along the checked driving path, and re-performing the determining whether a failure of the second LDC occurs.

In an example of the present disclosure, there is provided a method for controlling a redundancy power control system including a first low DC-DC converter (LDC) configured to convert a high-voltage into a first low-voltage, a first power distributor configured to supply the first low-voltage output from the first LDC to at least one first electrical load, a second LDC configured to convert the high-voltage into a second low-voltage, a second power distributor configured to supply the second low-voltage output from the second LDC to at least one second electrical load, and a bidirectional converter configured to convert power between the first low-voltage and the second low-voltage according to a power conversion request signal generated by one power distributor of the first power distributor and the second power distributor and provide the converted power to the other power distributor of the first power distributor and the second power distributor, wherein the method includes determining that a failure of the first LDC occurs, providing, by the second LDC, second maximum convertible output information to the second power distributor in response to a determination that the failure of the first LDC occurs, checking, by the second power distributor, a second current amount consumed by the at least one second electrical load, transmitting, by the second power distributor, second spare current amount information to the first power distributor based on the second maximum convertible output information and the second current amount, transmitting, by the first power distributor, a power conversion request according to a target current amount determined based on the second spare current amount information to the bidirectional converter, converting, by the bidirectional converter, a second low-voltage supplied from the second power distributor into a first low-voltage to supply the converted first low-voltage to the first power distributor within a range of the target current amount, and supplying power supplied from the first power distributor to the at least one first electrical load.

In an example, the determining that a failure of the first LDC occurs comprises determining that the first LDC fails if an output voltage of the first LDC is less than or equal to a preset threshold.

In an example, the first low-voltage may be lower than the second low-voltage.

In an example, the second spare current amount is calculated by subtracting the second current amount from the second maximum convertible output of the second LDC.

According to an example of the present disclosure, the redundancy power control system and the method for operating the same are provided to maximize the driving distance of the autonomous vehicle by converting the RPC converts power based on the available output capacity of the LDC in the normal source domain (power domain that is not failed). This technology may be used for the vehicle including two power converters, one of which has a relatively small capacity to increase the driving distance and induce stable stop when the power of the autonomous vehicle fails.

Although the examples have been described with reference to a number of illustrative examples thereof, it should be understood that numerous other modifications and examples can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed:

1. An apparatus of a vehicle, the apparatus comprising:
a first DC-DC converter configured to convert an input voltage into a first voltage;
a first power distributor configured to supply the first voltage output from the first DC-DC converter to at least one first electrical load;
a second DC-DC converter configured to convert the input voltage into a second voltage;
a second power distributor configured to supply the second voltage output from the second DC-DC converter to at least one second electrical load; and
a bidirectional converter configured to:
convert power between power associated with the first low-voltage and power associated with the second low-voltage based on a power conversion request signal generated by one power distributor of the first power distributor and the second power distributor, and
provide the converted power to the other power distributor of the first power distributor and the second power distributor,
wherein:
the first DC-DC converter is further configured to provide an indication of a first maximum convertible power output to the first power distributor, and
the second DC-DC converter is further configured to provide an indication of a second maximum convertible power output to the second power distributor,
wherein:
the first power distributor is further configured to determine a first spare current amount based on the first maximum convertible power output and a first current amount consumed by the at least one first electrical load and provide the first spare current amount to the bidirectional converter, and
the second power distributor is further configured to determine a second spare current amount based on the second maximum convertible power output and a second current amount consumed by the at least one second electrical load and provide the second spare current amount to the bidirectional converter, and
wherein:
the first power distributor is further configured to transmit, based on a failure in the first DC-DC converter, the power conversion request signal to the bidirectional converter for a first target current amount of power conversion, wherein the first target current amount is determined based on the second spare current amount, and
the second power distributor is further configured to transmit, based on a failure in the second DC-DC converter, the power conversion request signal to the bidirectional converter for a second target current amount of power conversion, wherein the second target current amount is determined based on the first spare current amount.

2. The apparatus of claim 1, wherein the first DC-DC converter outputs a voltage in a range from 11V to 13V.

3. The apparatus of claim 1, wherein the second DC-DC converter outputs a voltage in a range from 23V to 25V.

4. The apparatus of claim 1, wherein at least one of:
the first DC-DC converter is further configured to provide, based on a first set time period, the indication of the first maximum convertible power output to the first power distributor, or
the second DC-DC converter is further configured to provide, based on a second set time period, the indication of the second maximum convertible power output to the second power distributor.

5. The apparatus of claim 4, wherein:
the first target current amount of power conversion is determined based on the second current amount and a second maximum convertible output current amount of the second DC-DC converter within the second spare current amount, or the second target current amount of power conversion is determined based on the first current amount and a first maximum convertible output current amount of the first DC-DC converter within the first spare current amount.

6. The apparatus of claim 5, wherein:
the first current amount is determined based on a first moving average of first current data consumed by the at least one first electrical load over a first predetermined time, or
the second current amount is determined based on a second moving average of second current data consumed by the at least one second electrical load over a second predetermined time.

7. The apparatus of claim 6,
wherein:
the first DC-DC converter is configured to transmit at first predetermined time intervals, based on the vehicle being started, the first current data to the first power distributor, or
the second DC-DC converter is configured to transmit at second predetermined time intervals, based on the vehicle being started, the second current data to the second power distributor, and
wherein:
the first power distributor is further configured to determine, based on a failure in the first DC-DC converter, the first moving average of the first current data, or
the second power distributor is further configured to determine, based a failure in the second DC-DC converter, the second moving average of the second current data.

8. A method performed by an apparatus of a vehicle, the method comprising:
determining whether a failure of a second DC-DC converter occurs, wherein a first DC-DC converter converts an input voltage to a first voltage, and wherein the second DC-DC converter converts the input voltage to a second voltage;
providing, based on a determination that the failure of the second DC-DC converter occurs and using the first DC-DC converter, an indication of a first maximum convertible power output to a first power distributor, wherein the first power distributor supplies the first voltage output from the first DC-DC converter to at least one first electrical load;
checking, using the first power distributor, a first current amount consumed by the at least one first electrical load;
transmitting, based on the first maximum convertible power output and the first current amount and using the first power distributor, an indication of a first spare current amount to a second power distributor, wherein the second power distributor supplies the second voltage output from the second DC-DC converter to at least one second electrical load;
transmitting, based on a target current amount and using the second power distributor, a power conversion request to a bidirectional converter, wherein the target current amount is determined based on the first spare current amount;
converting, based on the power conversion request and using the bidirectional converter, power associated with the first low-voltage into power associated with the second low-voltage and supplying the converted power associated with the second voltage to the second power distributor within a range of the target current amount; and
supplying, to the at least one second electrical load, a combination of power received by the second power distributor from the bidirectional converter and power discharged from a second voltage battery associated with the second power distributor.

9. The method of claim 8, wherein the determining whether the failure of the second DC-DC converter occurs comprises determining that the second DC-DC converter failed based on an output voltage of the second DC-DC converter is less than or equal to a preset threshold.

10. The method of claim 8, wherein the second voltage is higher than the first voltage.

11. The method of claim 8, wherein the supplying the combination of power to the at least one second electrical load is performed until remaining power of the second voltage battery is less than or equal to a preset first threshold value.

12. The method of claim 11, wherein the preset first threshold value corresponds to a state of charge of the second voltage battery in a range from 59% to 61%.

13. The method of claim 11, further comprising:
stopping the vehicle based on the remaining power of the second voltage battery being less than or equal to a preset second threshold value; and
restricting power usage of the at least one first electrical load and the at least one second electrical load.

14. The method of claim 13, further comprising charging the second voltage battery to a preset third threshold value using power converted into the power associated with the second voltage by the bidirectional converter.

15. The method of claim 14, wherein the preset third threshold value corresponds to a state of charge of the second voltage battery in a range from 99% to 100%.

16. The method of claim 14, further comprising:
checking a driving path of the vehicle to a preset destination based on the second voltage battery being charged to the preset third threshold value;
driving the vehicle along the checked driving path; and
re-evaluating whether a failure of the second DC-DC converter occurs during the driving.

17. An apparatus comprising:
a processor; and
a memory storing at least one instruction that, when executed by the processor communicating with the memory, is configured to cause the apparatus to:
receive, from a plurality of power converters, respective power output information;
determine, for the plurality of power converters, a respective current consumption amount associated with at least one electrical load connected to a corresponding power converter;
determine, based on the respective power output information and the respective current consumption amount, a respective spare capacity for the plurality of power converters;
detect at least one power converter with a fault condition among the plurality of power converters;
determine, based on the fault condition and a spare capacity of at least one non-faulty power converter among the plurality of power converters, a target power conversion value; and
control, based on the target power conversion value, a bidirectional converter to convert power from the non-faulty power converter to compensate for the fault condition.

18. The apparatus of claim 17, wherein at least one of the plurality of power converters is configured to provide respective power output information to the processor at a set time interval.

19. The apparatus of claim 17, wherein the at least one instruction, when executed by the processor communicating with the memory, is configured to cause the apparatus to determine, based on a moving average of the respective current consumption amount over a predetermined number of previous time intervals, the respective spare capacity.

20. The apparatus of claim 17, wherein the at least one instruction, when executed by the processor communicating with the memory, is configured to cause the apparatus to control the bidirectional converter to:
convert power in a first direction in response to a first fault condition occurring in a first power converter of the plurality of power converters, and
convert power in a second direction in response to a second fault condition occurring in a second power converter of the plurality of power converters.
